(19) United States
(12) Patent Application Publication
(10) Pub. No.: US 2004/0230646 A1
(43) Pub. Date: Nov. 18, 2004

(54) Systems and methods for discovering a public printing service

(76) Inventors: James Clough, Boise, ID (US); Brian McKinley, Boise, ID (US); Dennis Howard, Eagle, ID (US); Darrel Cherry, Boise, ID (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/436,347

(22) Filed: May 12, 2003

(51) Int. Cl. G06F 15/16

(52) U.S. Cl. 709/203

(57) ABSTRACT

Disclosed are systems and methods for discovering a public printing service. In one embodiment, a system and a method pertain to automatically requesting from a printing service manager a network address to which print jobs can be sent and receiving from the printing service manager at least one network address to which print jobs can be sent.

### BACKGROUND

Computer users often carry portable computing devices with them such as notebook computers, personal digital assistants (PDAs), and mobile telephones that include computing capabilities. Such users may at some point wish to print data from the portable computing device while remote from the user's work or home network. For instance, a mobile user may wish to print when at a coffee shop that provides network (e.g., Internet) access and printing services, or when staying at a hotel that comprises a hotel network that includes a public printing device.

In such scenarios, it is likely that the user has little or no knowledge of the printing services that are available for use. Furthermore, it is likely that the user lacks the software (or firmware) that is required to communicate with the public printing devices and to send print jobs to them. Although the user can be provided with information as to the availability of printing services as well as any software or firmware (e.g., drivers) that is necessary to print, a more automated public printing system would be preferable, particularly for less computer-savvy users. Moreover, desirable would be a public printing system that is substantially universal and therefore may be used within any network that is configured to support such public printing.

Several obstacles exist to the creation and implementation of such a public printing system. For instance, the system must be designed to perform a discovery process through which the public printing service is automatically identified and any information required to access the service, such as network addresses, authorization codes, etc., obtained. Moreover, the system would preferably be designed so as to be consistent, i.e. universal at least as to other venues that support a like system.

### SUMMARY

Disclosed are systems and methods for discovering a public printing service. In one embodiment, a system and a method pertain to automatically requesting from a printing service manager a network address to which print jobs can be sent, and receiving from the printing service manager at least one network address to which print jobs can be sent.

### BRIEF DESCRIPTION OF THE DRAWINGS

The disclosed systems and methods can be better understood with reference to the following drawings. The components in the drawings are not necessarily to scale.

FIG. 1 is a schematic view of an embodiment of a system that facilitates public printing.

FIG. 2 is a block diagram of an embodiment of a computing device shown in FIG. 1.

FIG. 3 is a block diagram of an embodiment of a printing device shown in FIG. 1.

FIGS. 4A and 4B provide a flow diagram that illustrates an embodiment of a method for facilitating public printing using the system of FIG. 1.

FIG. 5 is a flow diagram that illustrates an embodiment of operation of a public printing client in discovering a public printing service.

FIG. 6 is a flow diagram that illustrates an embodiment of operation of a printing service manager in facilitating the discovery process described in FIG. 5.

FIG. 7 is a flow diagram that illustrates an embodiment of operation of the public printing client in printing using the discovered public printing service.

### DETAILED DESCRIPTION

Disclosed herein are example embodiments of systems and methods that facilitate public printing. Although particular embodiments are disclosed, these embodiments are provided for purposes of example only to facilitate description of the disclosed systems and methods.

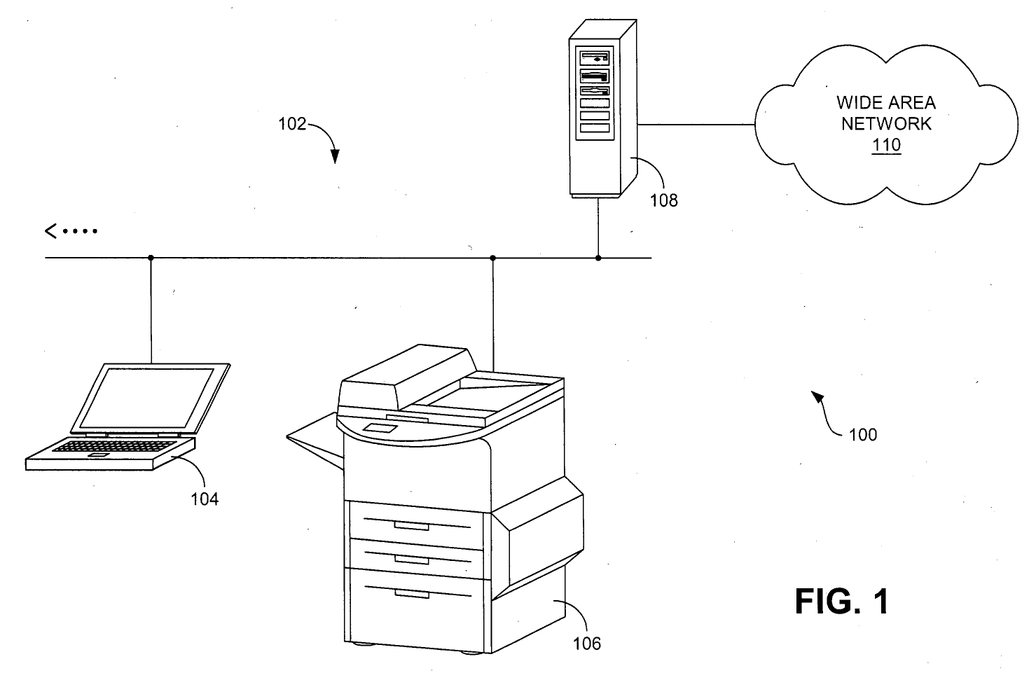

Referring now in more detail to the drawings, in which like numerals indicate corresponding parts throughout the several views, FIG. 1 illustrates an example system 100 that facilitates public printing. As indicated in this figure, the system 100 includes a local or internal network 102 to which a computing device 104, a printing device 106, and a server computer 108 are connected. The internal network 102 is assumed to comprise a network that is unfamiliar to the mobile user. By way of example, the internal network 102 comprises a hotel network to which the user can connect from the user's hotel room. Although a hotel network is explicitly identified for purposes of discussion, the internal network 102 more generally comprises any network (wired or wireless) that a mobile user may wish to connect to and print over.

As is depicted in FIG. 1, the computing device 104 can be a notebook (or “laptop”) computer. More generally, however, the computing device 104 comprises a portable computing device that the mobile-user may carry, for instance, while on a business trip. Accordingly, the computing device 104 can, alternatively, comprise one of a personal digital assistant (PDA), tablet computer, mobile telephone, etc. Irrespective of its configuration, the computing device 104 is connectable to the internal network 102 such that the computing device can communicate with one or both of the printing device 106 and the server computer 108. This connection may comprise either a wired connection or a wireless connection (e.g., via a radio frequency (RF) communication protocol). Stored on the computing device 104 is client software (or firmware) that is used to access and use a public printing service facilitated by a printing service manager.

The printing device 106 comprises any device that can receive print jobs via the internal network 102 and generate hardcopy documents associated with the received jobs. By way of example, the printing device 106 comprises a laser printer. However, other configurations are possible. For instance, the printing device 106 can be a multi-function peripheral (MFP) device that is capable of printing as well as performing other tasks such as copying, scanning, faxing, emailing, etc. As is described in greater detail below, the printing device 106 can comprise an embedded printing service manager that facilitates public printing.

The server computer 108 links the internal network 102 to an external wide area network (WAN) 110, such as the Internet, and therefore acts as a gateway between the internal network and the WAN. As is described below, the server computer 108 is configured to intercept initial communications directed at devices located outside of the internal network 102 (i.e. on the WAN 110). Such interception may be used to, for example, charge users for Internet access and/or offer printing services to the user. In the latter case, the server computer 108 may be configured to provide a link to the printing service manager that is, for instance, embedded in the printing device 106.

In addition to acting as the network gateway, the server computer 108 (or a separate computer if desired) may be used to provide the network address (e.g., Internet protocol (IP) address) of the printing service manager. Furthermore, the server computer 108 may facilitate billing for rendered printing services by, for instance, posting printing charges to a bill (e.g., hotel bill) or forwarding billing information to a credit card processing service connected to the WAN 110. It is noted that, in some embodiments, the printing service manager, or a portion thereof, may exist on the server computer 108 or another device connected to the network 102.

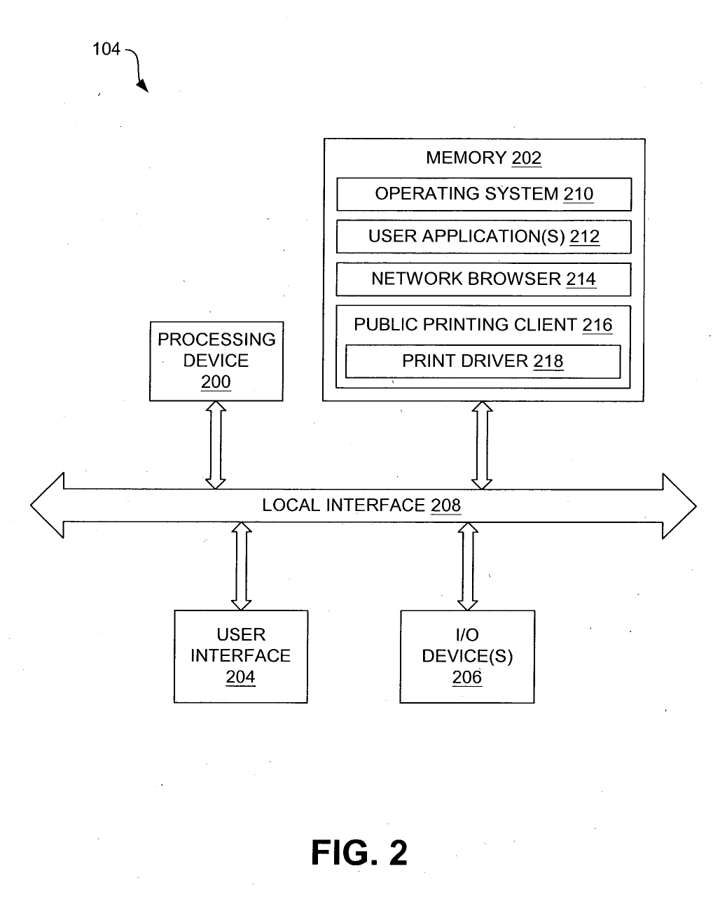

FIG. 2 is a block diagram illustrating an example architecture for the computing device 104 shown in FIG. 1. As indicated in FIG. 2, the computing device 104 comprises a processing device 200, memory 202, a user interface 204, and at least one input/output (I/O) device 206. Each of these components is connected to a local interface 208 that, for instance, comprises one or more internal buses.

The processing device 200 is adapted to execute commands stored in memory 202 and can comprise a general-purpose processor, a microprocessor, one or more application-specific integrated circuits (ASICs), a plurality of suitably configured digital logic gates, or other electrical configurations that coordinate the overall operation of the computing device 104. The memory 202 comprises any one or a combination of volatile memory elements (e.g., random access memory (RAM)) and nonvolatile memory elements (e.g., Flash memory, hard disk, etc.) that store or cache data.

The user interface 204 comprises the tools with which user data and commands are input into the computing device 104. In situations in which the computing device 104 comprises a notebook computer, the user interface 204 at least comprises a keyboard and a display. In other embodiments, the user interface may comprise one or more of function keys, buttons, a touch-sensitive display, and a stylus.

The one or more 1/0 devices 206 facilitate communications with other devices and may include one or more serial, parallel, small computer system interface (SCSI), universal serial bus (USB), or IEEE 1394 (e.g., Firewire™) components, as well as one or more of a modulator/demodulator (e.g., modem), network card, wireless (e.g., RF) transceiver, or other communication component.

The memory 202 includes various programs, in software and/or firmware, including an operating system 210, one or more user applications 212, and a network browser 214. The operating system 210 controls the execution of other software and provides scheduling, input-output control, file and data management, memory management, and communication control and related services. The user applications 212 comprise the programs that may be used to create and/or identify data (e.g., documents) that is to be printed by the service and, more particularly, by the printing device 106. By way of example, these applications comprise one or more of a word processing application, a spreadsheet application, a presentation application, a scheduling application, etc. The network browser 214 comprises a program with which the user can access, via the internal network 102, network sites and pages. By way of example, the network browser 214 is an Internet browser that retrieves Web sites and Web pages. The network browser 214 can be used to access the printing service manager.

In addition to those programs, the memory 202 comprises a public printing client 216. As is described in greater detail below, the public printing client 216 operates in conjunction with the printing service manager to facilitate public printing. By way of example, the public printing client 216 can be downloaded from the printing service manager or from a suitable source on the WAN 110. In any case, however, once stored on the computing device 104, the public printing client 216 can be used to facilitate public printing on any network in which an appropriate printing service manager is provided, thereby providing a substantially universal printing solution.

As is further identified in FIG. 2, the public printing client 216 includes a print driver 218 that is used to translate documents into an appropriate print format. Alternatively, however, the driver 218 could comprise part of the operating system 210. In preferred embodiments, the print driver 218 is a universal driver that can be used in conjunction with substantially any printing device that may be accessed via a compatible printing service manager. Examples of operation of the public printing client 216, and its print driver 218, are provided below.

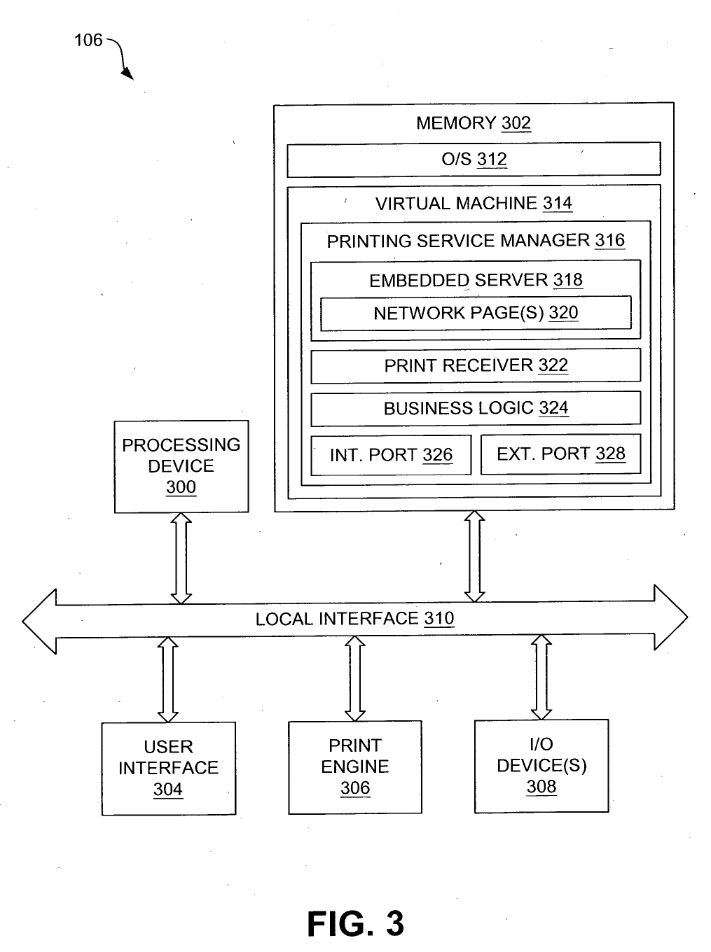

FIG. 3 is a block diagram illustrating an example architecture for the printing device 106 shown in FIG. 1. As indicated in FIG. 3, the printing device 106, like the computing device 104, comprises a processing device 300, memory 302, a user interface 304, and at least one I/O device 308, each of which is connected to a local interface 308. In addition, however, the printing device 106 comprises a print engine 306.

The processing device 300, memory 302, and I/O devices 308 have similar configurations to like-named components of the computing device 104 described in relation to FIG. 2. The user interface 304 comprises the components with which users input commands and modify device settings, such as a control panel that incorporates a display (e.g., liquid crystal display (LCD)) and a series of keys or buttons.

The memory 302 comprises various programs, in software and/or firmware, including an operating system 312 and, in this embodiment, a virtual machine 314. The operating system 312 contains the various commands that are used to control the general operation of the printing device 106. The virtual machine 314 is a program that functions as a self-contained operating environment and facilitates operation of a printing service manager 316 that, as noted above, facilitates public printing. Although a virtual machine is explicitly shown and identified, its functionality could, alternatively, be provided by software or firmware stored in the printing device 106. In the embodiment of FIG. 3, however, the manager 316 comprises an applet (e.g., written in the Chai™ programming language of the Hewlett-Packard Company) that includes an embedded server 318, a print receiver 322, and business logic 324. It is noted that, although the printing service manager 316 is shown as executing on the printing device 106, it could alternatively be provided on a separate device, such as the server computer 108 or another device connected to the internal network 102, if desired.

The embedded server 318 is configured to serve network pages 320, for instance Web pages, to requesting devices such as the computing device 104. As is described below, these pages contain information for the user as to how to use the public printing system hosted by the printing service manager 316, how to obtain public printing client software, the cost of the printing services, the methods of paying for those services, etc.

The print receiver 322 is a module that is configured to receive print jobs transmitted to the printing device 106 via the internal network 102. By way of example, the print receiver 322 is specifically configured to receive hypertext transfer protocol (HTTP) and/or secure HTTP (HTTPS) communications. These communications can be received via an internal port 326 and an external port 328 that each has its own network address (e.g., universal resource locator (URL)) that is used to access the port. In some embodiments, the internal port 326 and the external port 328 may comprise the same port. When a print job is received, the print receiver 322 forwards the job to the print engine 306 for printing.

Once printing has been successfully performed, billing (assuming the printing services are provided on a pay basis) is facilitated using the business logic 324. Operation of the business logic 324 depends upon the particular implementation and method of billing that is to be used. By way of example, the business logic 324 is configured to communicate printing charges to the server computer 108 for purposes of posting those charges to a bill (e.g., hotel bill) or contacting an appropriate credit card processing service.

Various programs (i.e. logic) have been described herein. These programs can be stored on any computer-readable medium for use by or in connection with any computer-related system or method. In the context of this document, a “computer-readable medium” is any electronic, magnetic, optical, or other physical device or means that contains or stores a computer program for use by or in connection with a computer-related system or method. These programs can used by or in connection with an instruction execution system, apparatus, or device, such as a computer-based system, processor-containing system, or other system that can fetch the instructions from the instruction execution system, apparatus, or device and execute the instructions.

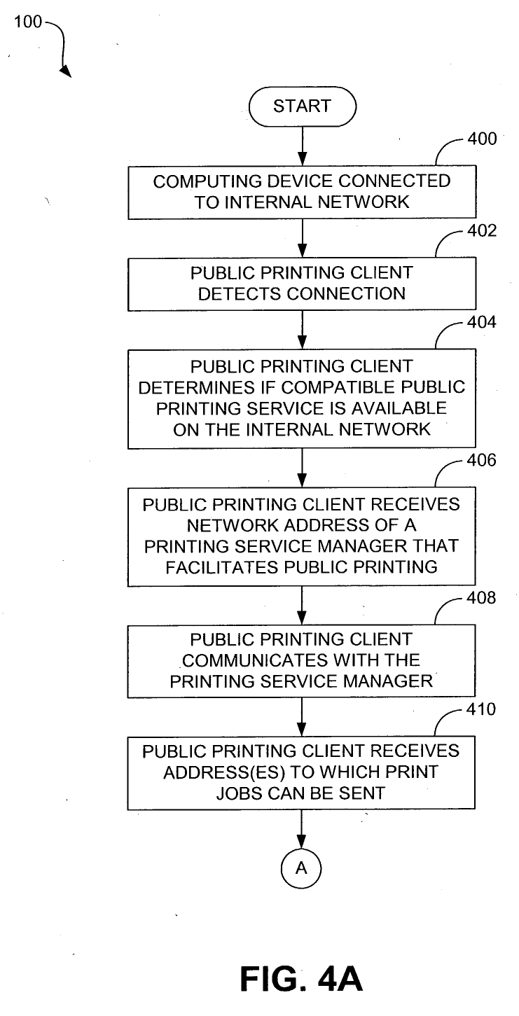

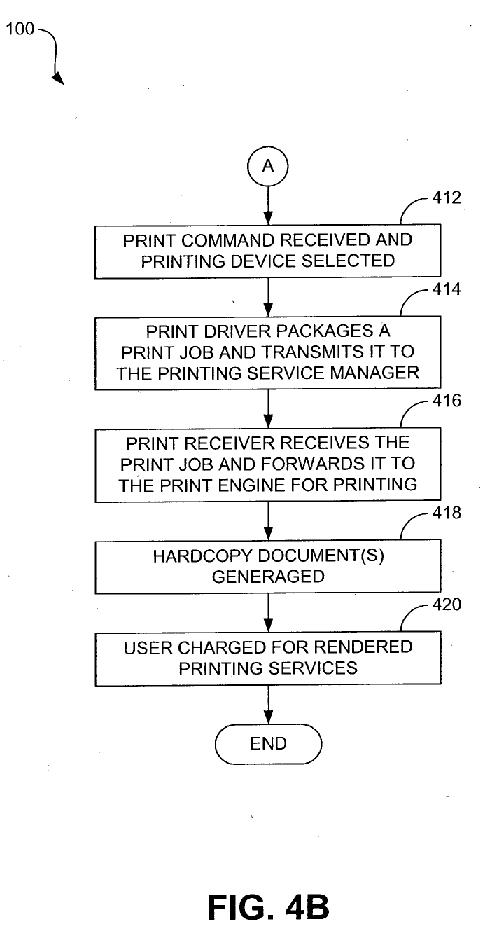

An example system having been described above, an example of operation of the system in facilitating public printing will now be discussed in relation to the flow diagram of FIGS. 4A and 4B. It is noted that process steps or blocks in the flow diagrams of this disclosure may represent modules, segments, or portions of code that include one or more executable instructions for implementing specific logical functions or steps in the process. Although particular example process steps are described, alternative implementations are feasible. Moreover, steps may be executed out of order from that shown or discussed, including substantially concurrently or in reverse order, depending on the functionality involved.

Beginning with block 400 of FIG. 4A, the computing device 104 (FIG. 1) is connected to the internal network 102. By way of example, the computer user may physically connect his or her notebook computer to a hotel network (e.g., high speed data port in the user's hotel room). Once the computing device 104 is connected to the network 102, the public printing client 216 (FIG. 2) on the computing device detects the connection, as indicated in block 402. Such detection can be made because the public printing client 216 continuously runs in the background on the computing device 104 and therefore continually monitors the network state of the device. Notably, the public printing client 216 could have been installed in a previous public printing session. For example, during that session, the computer user could have been made aware of the availability of the client software and the printing services it facilitates by, for example, a Web page served by the server computer 108. In such a case, the client software could have been obtained by, for instance, retrieving it from a server connected to the WAN 110 and operated by or on the behalf of the client software developer.

Referring next to block 404, the public printing client 216 determines if a compatible public printing service is available on the internal network 102. This determination can be made by performing a domain name service (DNS) lookup for a domain name associated with the public printing service that a DNS server (e.g., server computer 108) is configured to recognize. By way of example, a DNS lookup of the name “mobile.printing” can be performed. If a compatible public printing service is available, the public printing client 216 receives a network address of a printing service manager 316 (FIG. 3) that facilitates such public printing, as indicated in block 406. More particularly, the public printing client 216 receives an Internet protocol (IP) address of the printing service manager 316, for example stored on the printing device 106 or the server computer 108 as the case may be.

Once the public printing client 216 receives the address of the printing service manager 316, the public printing client makes a call to that address so that the client can communicate with the printing service manager 316, as indicated in block 408. Such communications are supported using an appropriate network protocol, such as HTTP or HTTPs. Through these communications, the public printing client 216 receives one or more network addresses to which print jobs can be sent for printing by one or more available printing devices 106, as indicated in block 410. By way of example, the address or addresses comprise one or more URLs that identify input ports (e.g., the internal and external ports) of the printing service manager 316 on the printing device 106 or the server computer 108. This information, as well as other information that facilitates printing, can, for instance, be contained in an extensible markup language (XML) document that is transmitted from the printing service manager 316 to the public printing client 216. At this point, the public printing client 216, and therefore the computing device 104, has completed a public printing service discovery process and therefore is prepared to print to the printing device 106.

The user can learn about the public printing service in various ways. For example, when the user opens the network browser 214, the server computer 108 can intercept that connection and inform the user as to the availability of the public printing service and provide a link to the printing service manager 316. Assuming the user wishes to use or is considering using the public printing service, the user can then select the link and receive one or more network (e.g., Web) pages from the embedded server 318 of the printing service manager 316 that explain how to use the service, how much the service costs (e.g., price per page), how the user is billed, where printed documents may be picked up, etc.

At print time, a print command is received and a printing device is selected, as indicated in block 412 of FIG. 4B. By way of example, the print command and printing device selection are made using a “File, Print” process in which the user is presented with a list of available printing devices from which to choose. In such a case, the presented list includes the printing device 106 connected to the internal network 102. After the print command and printing device selection have been entered, and assuming the user selected the printing device 106, the public printing client 216 packages a print job and transmits it to the printing service manager 316, as indicated in block 414. Alternatively, however, packaging of the print job can have occurred previous to entry of the print command and printing device selection. Preferably, the print job is transmitted using a secure network protocol such as HTTPS. Regardless, the print job is transmitted to an address (e.g., URL) that the public printing client 216 received in block 410 described above.

After or while the print job is transmitted, the print receiver 322 of the printing service manager 316 receives the print job and forwards it to the print engine 306 for printing, as indicated in block 416, so that, as indicated in block 418, one or more hardcopy documents are generated. If the printing service manager 316 is executing on a device separate from the printing device 106, for instance on the server computer 108, the print job is transmitted from that device to the printing device using substantially any available transmission method (wired or wireless). Once printing has been successfully completed (in whole or in part), the user is charged for the printing services rendered, as indicated in block 420. As noted above, such a charge can be, for instance, added to a hotel bill or forwarded to a credit card processing service for debiting of a credit card account. Assuming no other documents are to be printed, flow for the public printing session is then terminated.

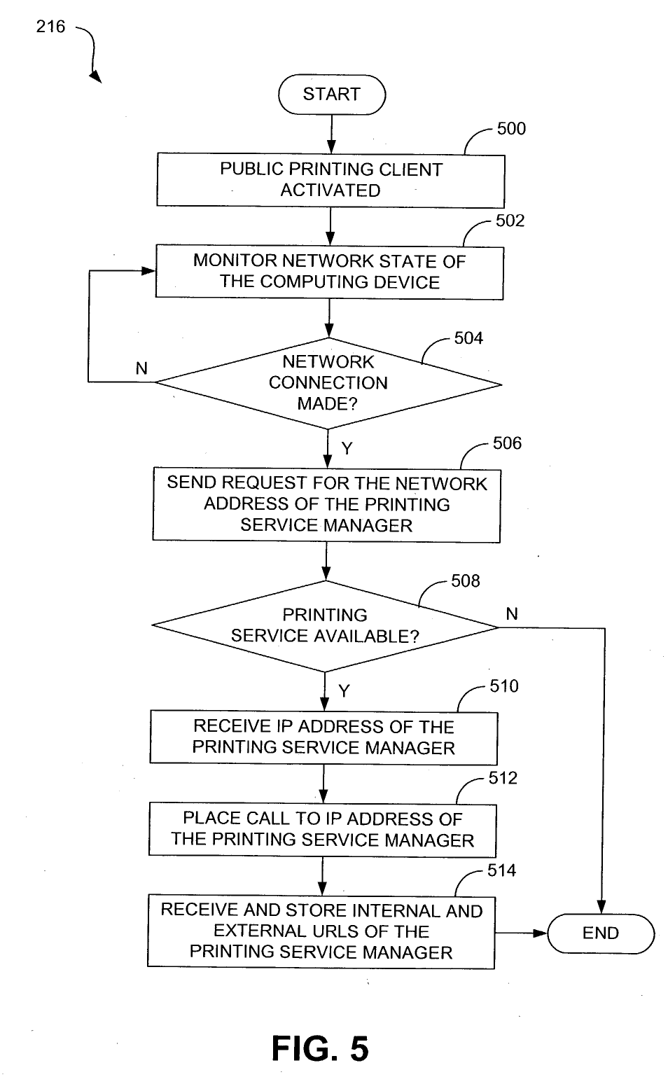

As noted above, several obstacles exist to the creation and implementation of a public printing system such as that described in relation to FIGS. 1-4. For instance, if the system is to be substantially automatic, the method in which the printing service, and any information necessary to use it, is discovered should likewise be automatic. FIG. 5 is a flow diagram that illustrates an embodiment of such a discovery process. More particularly, FIG. 5 illustrates an example of operation of the public printing client 216 (FIG. 2) in discovering the printing service and the information the client needs to access and use the service.

Beginning with block 500, the public printing client 216 is activated. This activation occurs, for instance, when the computing device 104 (FIG. 1) on which the client 216 runs is powered and booted. In any case, however, once activated the public printing client 216 monitors the network state of the computing device 104, as indicated in block 502, so that the client can detect when the computing device is connected to a network (e.g., internal network 106). By performing this monitoring, it can be determined, as indicated in decision block 504, whether a network connection has been made. If not, flow returns to block 502 at which the public printing client 216, which runs in the background on the computing device 104, continues to monitor the device network state.

If a network connection is detected, flow continues from decision block 504 to block 506 at which the public printing client 216 sends a request for the network address of the printing service manager 316 (FIG. 3) of the public printing service. As is described above, this request can comprise a DNS lookup for a domain name associated with the public printing service. However, other methods may be used to obtain the printing service manager address. For instance, a service location protocol (SLP) request can be sent to an appropriate device, a request can be generally broadcast on the internal network 106, or the address can simply be located from an appropriate directory.

Next, with reference to decision block 508, it is determined whether the network to which the computing device 104 has been connected supports a compatible public printing service. By way of example, the availability or unavailability of the service is determined from a response identifying the address, a response indicating that no such address was found, or no response at all. If no address is found or no response is received, printing is not available using the public printing client 216 and flow is terminated. If, on the other hand, an appropriate response is received, flow continues to block 510 at which the public printing client 216 receives the network (e.g., IP) address of the printing service manager 316.

Once the IP address of the printing service manager 316 has been obtained, the public printing client 216 places a call to that IP address, as indicated in block 512, to request a network address to which print jobs can be directed, and any other information that is required to print. Such a communication can be supported using an appropriate network protocol, such as HTTP or HTTPS. In such a case, the request may comprise, for instance, a “GET PSMinfo” command.

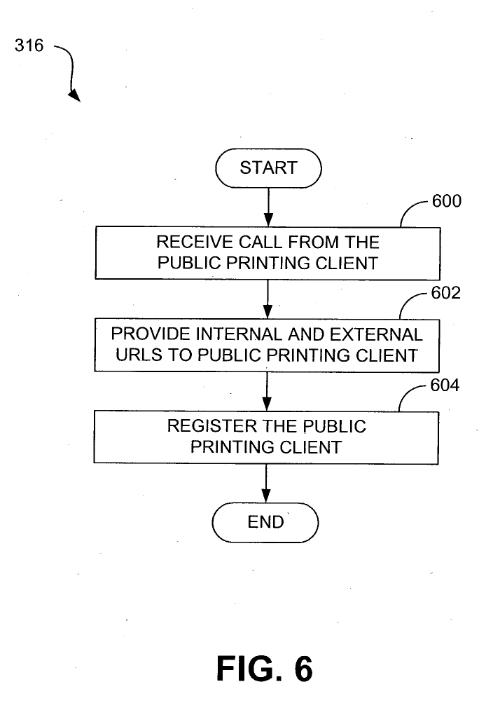

Referring now to FIG. 6, which illustrates an example of operation of the printing service manager 316 (e.g., executing on the printing device 106 or the server computer 108) in providing to the public printing client 216 the information requested in the call of block 512. Beginning with block 600 of FIG. 6, the printing service manager 316 receives the call from the public printing client 216. Upon receiving this call, the printing service manager 316 sends at least one URL, for instance an internal URL associated with the internal port 326, and an external URL associated with the external port 328, as indicated in block 602. As mentioned previously, these two ports 326, 328 may be one and the same port in which case either URL can be used to reach that same port. As also mentioned above, this information can be provided to the public printing client 216 in an XML document. Regardless, the information preferably is provided via a secure network protocol, such as HTTPS, although HTTP may be used, if desired.

Notably, other information can be provided to the public printing client 216. For instance, one or more authorization codes that are used to identify the public printing client 216 at print time may be provided, for example, by embedding them into the URLs. The printing service manager 316 can also provide information as to the version number of the printing service manager, the protocol used by the printing service manager, information about the venue in which the printing service operates, etc. With reference next to block 604, the printing service manager 316 can further register the public printing client 216 by storing information about the client in an appropriate database. Such registration, when performed, may occur before, concurrent with, or after transmission of the URLs.

Returning to FIG. 5, internal and external URLs, and any other transmitted information, are received by the public printing client 216, as indicated in block 514, to complete the discovery process. The URLs can either be cached in a registry or stored into memory. At this point, the public printing client 216, and therefore the computing device 104, is prepared to print using the public printing service.

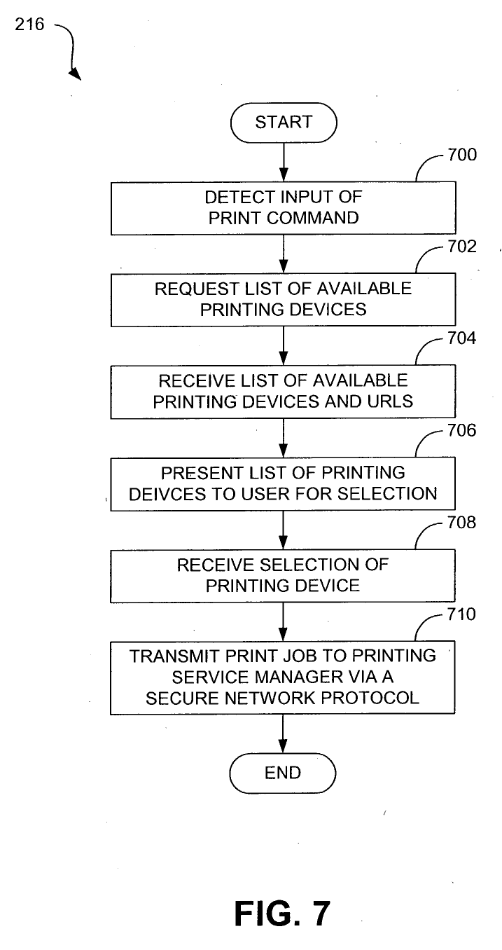

FIG. 7 is a flow diagram that illustrates an embodiment of printing using the discovered public printing service. In particular, FIG. 7 illustrates an example of operation of the public printing client 216 (FIG. 2) in printing using the public printing service after the discovery process described in relation to FIGS. 5 and 6 has been completed.

Beginning with block 700 of FIG. 7, the public printing client 216 detects input of a print command. This command can have been registered, for example, in substantially any one of the user applications 212. In any case, once the print command is detected, the public printing client 216 requests a list of all the printing devices 106 that are available for printing, as indicated in block 702. This request is again transmitted in a network protocol such as HTTP or HTTPS. By way of example, the request can comprise a “GET printerlist” command. Furthermore, any authorization codes obtained from the printing service manager 316 (FIG. 3) during discovery can be transmitted along with the request.

Assuming the public printing client 216 is determined by the printing service manager 316 to be authorized to receive the requested information, a list of the available printing devices 106 and their associated URLs is received, as indicated in block 704. Notably, the printing devices 106 identified to the public printing client 216 may depend upon what information the printing service manager 316 has about the client (e.g., as determined from its authorization code) and its physical location. Other information that may affect the user's printing device selection can accompany this list including, for example, printing prices as to each printing device, capabilities possessed by each printing device, locations of each of the printing devices, and so forth. The printing device list, as well as any associated information obtained in block 704, is then be presented to the user, using a suitable graphical user interface (GUI), as indicated in block 706. The user can then review the presented information and choose the printing device to which the user would like to print. After such a selection is made, it is received by the public printing client 216, as indicated in block 708.

Once the printing device selection has been received, the public printing client 216 transmits the print job to the printing service manager 316, as indicated in block 710. Specifically, the public printing client posts the job data, preferably via a secure network protocol, such as HTTPS, to a print job URL obtained in block 514 of FIG. 5.

What is claimed is:

1. A method for discovering a public printing service, comprising:
automatically requesting from a printing service manager a network address to which print jobs can be sent; and
receiving from the printing service manager at least one network address to which print jobs can be sent.

2. The method of claim 1, wherein automatically requesting a network address comprises sending a request to the printing service manager to a network address via a network protocol.

3. The method of claim 2, wherein sending a request comprises sending a request via secure hypertext transfer protocol (HTTPS).

4. The method of claim 1, wherein receiving at least one network address comprises receiving at least one network address from a printing service manager executing on a printing device.

5. The method of claim 1, wherein receiving at least one network address comprises receiving an internal network address and an external network address of the printing service.

6. The method of claim 5, wherein receiving an internal network address and an external network address comprises receiving an internal universal resource locator (URL) associated with an internal port of the printing system and an external URL associated with an external port of the printing system.

7. The method of claim 1, further comprising receiving from the printing service manager an authorization code.

8. The method of claim 1, further comprising detecting a network connection and, in response, automatically requesting a network address of the printing service manager prior to automatically requesting a network address to which print jobs can be sent.

9. The method of claim 8, wherein automatically requesting a network address of the printing service manager comprises automatically performing a domain name service (DNS) lookup of a domain name associated with the printing service.

10. The method of claim 8, further comprising receiving a network address of the printing service manager in response to the request for that network address.

11. The method of claim 10, wherein receiving a network address of the printing service manager comprises receiving an Internet protocol (IP) address of the printing service manager.

12. A system for discovering a public printing service, comprising:
a public printing client,configured to request from the printing service manager a network address to which a print job can be sent; and
a printing service manager configured to provide at least one network address to which a print job can be sent.

13. The system of claim 12, wherein the printing service manager is configured for execution on a printing device.

14. The system of claim 12, wherein the printing service manager is configured to provide an internal network address and an external network address of the printing service.

15. The system of claim 12, wherein the printing service manager is configured to provide an internal universal resource locator (URL) associated with an internal port of the printing service and an external URL associated with an external port of the printing service.

16. The system of claim 12, wherein the public printing client is configured for execution on a computing device from which the print job originates.

17. The system of claim 12, wherein the public printing client is configured to automatically request a network address via secure hypertext transfer protocol (HTTPS).

18. The system of claim 12, wherein the public printing client is further configured to detect a network connection and, in response, automatically request a network address of the printing service manager prior to automatically requesting a network address to which the print job can be sent.

19. The system of claim 12, wherein the public printing client is further configured to, receive and store internal and external network addresses associated with the printing service to which print jobs can be sent.

20. A system for discovering a public printing service, comprising:
means for automatically requesting and receiving a network address of a printing service manager;
means for automatically requesting and receiving from the printing service manager a network address to which print jobs can be sent; and
means for receiving from the printing service manager and storing at least one network address to which print jobs can be sent.

21. The system of claim 20, wherein the means for automatically requesting and receiving a network address comprise means for automatically sending a request to the printing service manager to a network address via a network protocol.

22. The system of claim 20, wherein the means for receiving and storing at least one network address comprises means for receiving and storing an internal network address and an external network address of the printing service.

23. The system of claim 20, further comprising means for detecting a network connection.

24. A computing device, comprising:
a processing device; and
memory including a public printing client that is configured to automatically determine a network address of a printing service manager of a public printing service, to automatically request from the printing service manager a network address to which print jobs can be sent, and to receive from the printing service manager at least one network address to which print jobs can be sent.

25. The device of claim 24, wherein the public printing client is further configured to detect a network connection and, in response, request a network address of the printing service manager prior to automatically requesting a network address to which print jobs can be sent.

26. A public printing client stored on a computer-readable medium, the client comprising:
logic configured to automatically determine a network address of a printing service manager of a public printing service, to automatically request from the printing service manager a network address to which print jobs can be sent, and to receive from the printing service manager at least one network address to which print jobs can be sent.

27. The client of claim 26, further comprising logic configured to detect a network connection and, in response, automatically request a network address of the printing service manager prior to requesting a network address to which print jobs can be sent.

28. A printing service manager stored on a computer-readable medium, the manager comprising:
logic configured to provide an internal network address and an external network address of a printing service to which print jobs can be sent.

29. The manager of claim 28, wherein the manager is configured to provide the network addresses via a secure network protocol.

30. The manager of claim 28, wherein the manager is configured to provide an internal universal resource locator (URL) associated with an internal port of the printing service and an external URL associated with an external port of the printing service.

31. A method of printing to a public printing system, comprising:
automatically discovering the printing system;
automatically requesting a list of available printing devices and their network addresses from a printing service manager identified in the discovering step; and
transmitting a print job to a network address of one of the available printing devices via a network protocol.

32. The method of claim 31, wherein transmitting a print job comprises transmitting via a secure network protocol a print job to a universal resource locator (URL) received from the printing services manager.

33. A public printing client stored on a computer-readable medium, the client comprising:
logic configured to automatically request an address of a printing service manager;
logic configured to automatically request a list of available printing devices and their network addresses from the printing service manager; and
logic configured to transmit a print job to a network address of one of the available printing devices via a network protocol.
